(19) United States
(12) Patent Application Publication
(10) Pub. No.: US 2010/0090844 A1
(43) Pub. Date: Apr. 15, 2010

(54) Telephone interface shut off system

(76) Inventors: Harold Shirlee, Little Rock, AR (US); Steve Menhart, Little Rock, AR (US); Wenle Zhang, Little Rock, AR (US)

Correspondence Address: Harold Shirlee, 5406 Dreher Lane, Little Rock, AR, 72209, US

(21) Appl. No.: 12/287,492

(22) Filed: Oct. 10, 2008

(51) Int. Cl. G08B 17/10

(52) U.S. Cl. 340/628

(57) ABSTRACT

A Gas and Electric Alarm Shut Off System with a Telephone Interface System is an invention that will prevent smoke from growing into a fire and alert the user by telephone. This will save lives, property and alert the user.

### BACKGROUND OF THE INVENTION

The invention relates to a smoke alarm system that will not only detect when there is smoke, but will shut off the supply of gas or electric from the appliance to prevent the smoke from growing into a fire, plus alert the user by phone if the user is away from the house where the system is installed.

There are many types of smoke alarm systems already in use. However, many of these will only detect when there is smoke or fire. There are some that will respond to the smoke or fire by a water sprinkle system. With the water sprinkle system sometimes that which is not damaged by the smoke and fire is damaged by the water sprinkle system.

Unfortunately, there isn't a smoke or fire alarm system that will actually prevent the smoke from growing into a fire without causing additional damage (like water damage). Thus there is a need for a system that will not only detect smoke, but will go a step further and prevent the smoke from growing into a fire without causing further damage. This is what this Alarm Shut Off System with a Telephone Interface System does. This invention will detect the smoke and then shut the supply of gas or electric power off from the appliance, then alert the user by phone if the user is not at home at the time the Shut Off System is activated This will prevent the smoke from growing into a fire without causing further damage, and alert the user, thus saving lives and property.

### SUMMARY OF THE INVENTION

The object of this invention is to provide a smoke or fire alarm system that will prevent a smoke from growing into a fire without adding further damage, and alert the user by phone who may not be home when the Alarm Shut Off System with a Telephone Interface System is activated. To accomplish this objective an “Alarm Shut Off System with a Telephone Interface System” will be installed between the supply line (gas or electric) and the appliance. A smoke detector that comes with the system has a TRANSMITTER wired inside of the smoke detector. When the smoke detector is activated to send out the alarm warning signal the TRANSMITTER is activated to send out a signal to a RECIEVER on the Alarm Shut Off System.

The RECEIVER will receive a signal from the alarm TRANSMITTER. When the RECEIVER receives a signal from the alarm TRANSMITTER the RECIEVER will activate a user controller POTENTIOMETER. The user may set the POTENTIOMETER to the amount of time the user wants to expire before the Alarm Shut Off System shuts off the supply of gas or electric from the appliance. If the user brings the situation under control before the selected time expires the user should push the RESET BUTTON. This will stop the POTENTIOMETER'S count down and prevent the Alarm Shut Off System from shutting the supply of gas or electric from the appliance, as well as resetting the Alarm Shut Off System for duty.

However, if the user is not around or fails to bring the situation under control before the selected amount of time on the POTENTIOMETER has expired the Alarm Shut Off System will automatically shut off the supply of gas or electric from the appliance in order to prevent the situation from growing into a fire. When the Alarm Shut Off System has shut off a Telephone Interface System will alert the user by phone in case the user is not home. This in effect will save lives and property and alert the user by phone.

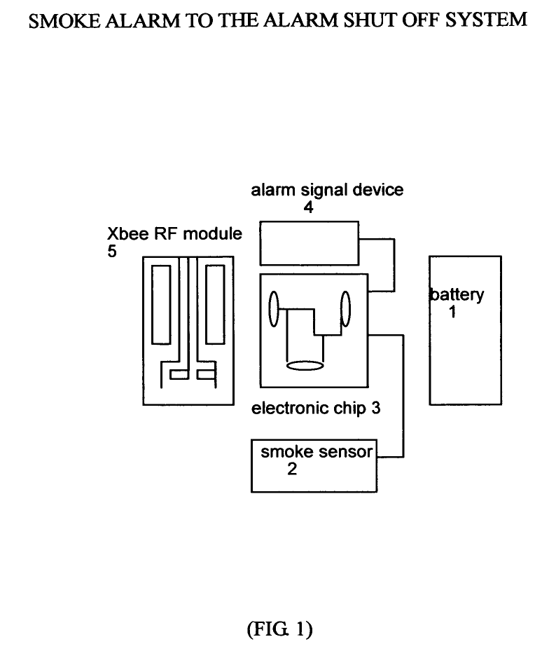

### DETAILED DESCRIPTION AND OPERATION OF THE GAS SMOKE DETECTOR ALARM (FIG. 1)

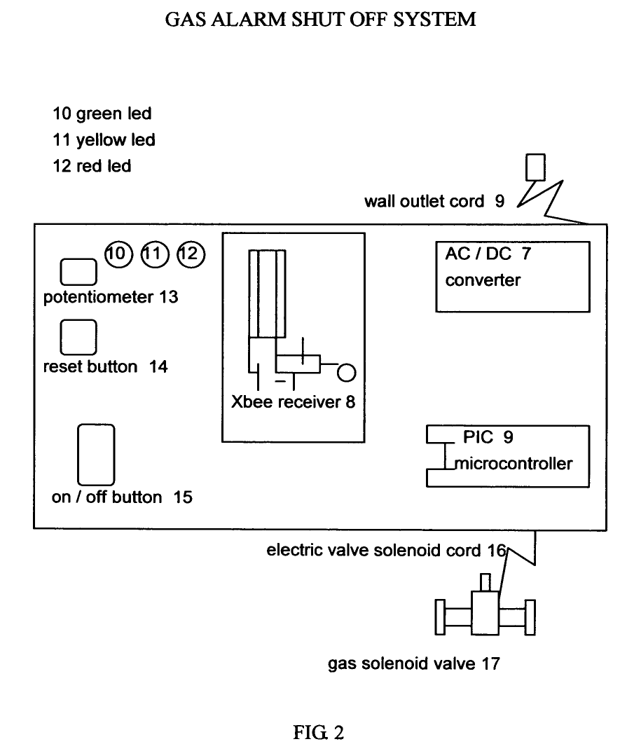

The Smoke Detector (FIG. 1) comes as a part of the Alarm Shut Off System. It is operated by battery (1). First a smoke sensor (2) will detect smoke. It will send that detection through an electronic chip (3) to an alarm signal device (4) that makes the smoke alarm sound. A Xbee RF module board (5) is wired directly into an alarm signal device (4). Therefore the same signal that the electronic chip (3) sends to the alarm signal device (4) is also sent to the Xbee RF module board (5). The Xbee RF module board (5) transmits a signal to the Shut Off System (FIG. 2) at the same time that the smoke alarm is sounding.

### DETAILED DESCRIPTION AND OPERATION OF THE GAS ALARM SHUT OFF SYSTEM (FIG. 2)

The Gas Shut Off System is powered from a 110 V AC (6), using a 5V AC-DC converter (7). The Gas Shut Off System receives the transmitted signal from a smoke detector (FIG. 1) via another Xbee module board (8) configured as a receiver. A PIC microcontroller (9) controls the functionality of the Shut Off System. When the Shut Off System is armed (turned on) a PIC microcontroller causes a green LED (10) to light. Upon receiving a signal from a Xbee module board receiver (8) a PIC microcontroller (9) will cause a yellow LED (11) to light. PIC lights are set by a user controller potentiometer (13). If at the end of the delay time and the user has not turned off the Alarm Shut Off System with the off button (15), or pressed a reset button (14), a PIC Microcontroller (9) will send a signal through an electrical cord (16) to a gas solenoid valve (17) to shut off the gas from the incoming gas supply line (18). Once the gas supply line (18) is shut off the PIC microcontroller (9) will cause a red LED (12) to light showing that the Gas Shut Off System has shut off the gas supply from the appliance. The smoke will not grow into a fire. Thus, lives and property have been saved.

RESET: The user may restore the supply of gas to an appliance by pressing a reset button (14). A green LED (10) will come on. The green LED (10) means that the Gas Shut Off System is reset and armed again.

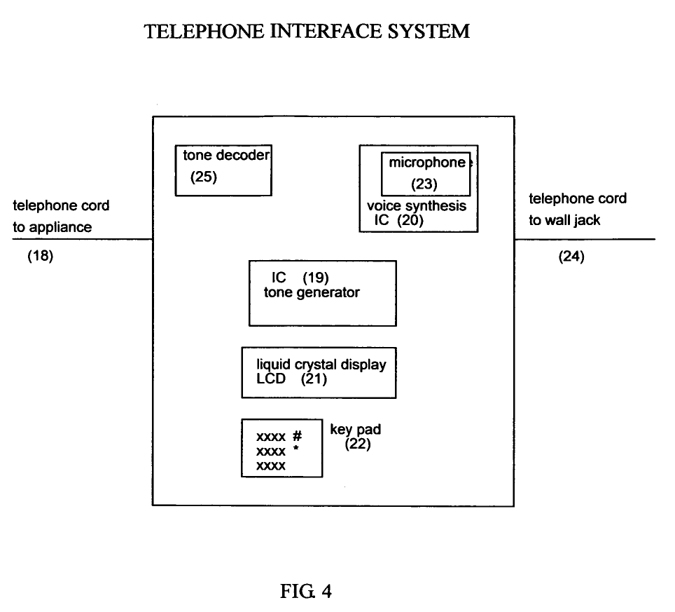

### DETAILED DESCRIPTION AND OPERATION OF THE GAS TELEPHONE INTERFACE SYSTEM (FIG. 4)

The system plugs into a standard phone jack (25) and is connected to the Shut Off Unit using a standard phone cord. When the Shut Off Unit has disconnected the supply of gas or electricity from the appliance and the user is away from the house a Telephone Interface System will notify the user of the action of the Shut Off System by dialing a preprogrammed telephone number and playing a prerecorded message.

Operation of the Telephone Interface System (FIG. 4), following the numbering system of the Gas Shut Off System (FIG. 2): When the Shut Off Units (FIG. 2) disconnects the supply of gas a Telephone Interface System (FIG. 4) will dial a phone number using a tone generator IC (18) and play a short message using a voice synthesis IC (19). A liquid crystal display (LCD) (20) is used to provide the user with feedback and instructions. A keypad (21) allows the user to enter a telephone number and respond to prompts. Pressing a specific key on the keypad (such as the # key) will initiate a process whereby the user is directed to enter a number to be dialed when the unit has disconnected and also to record a short message using the microphone (22). This message will be played to the user upon pick-up of a remote phone (the number that the Telephone Interface System will dial).

The Telephone Interface System also allows the user to disconnect the supply of gas or electricity from the appliance remotely (if the user forgets to turn the appliance off before leaving home). Using a remote phone (or a telephone at another location) the user will dial the phone to which the Shut Off System is connected and enter a code using a touch-tone phone key. A tone detector IC (23) will decode the code and a PIC microcontroller (24) will compare it to a code previously programmed into the Shut Off System, via a keypad and LCD. If the code matches then the gas or electricity will be disconnected. The system will provide the user with confirmation of the disconnection by means of a short beep.

### DETAILED DESCRIPTION AND OPERATION OF THE ELECTRIC SMOKE DETECTOR ALARM (FIG. 1)

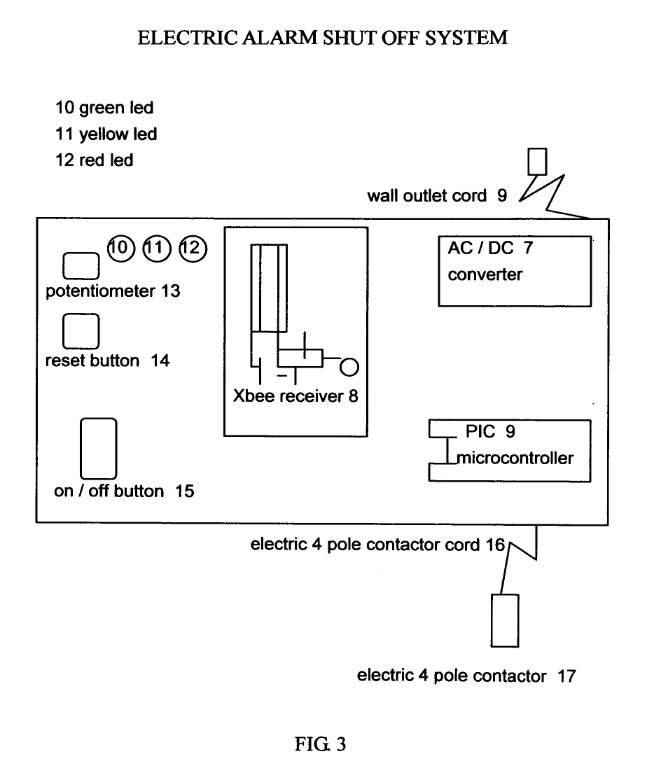

Repeating the detailed description and operation of the Smoke Detector Alarm (FIG. 1) that operates the Gas Alarm Shut Off System (FIG. 2). It performs the same operation on the Electric Alarm Shut Off System (FIG. 3). It is operated by battery (1). First a smoke sensor (2) will detect smoke. It will send that detection through an electronic chip (3) to an alarm signal device (4) that makes the smoke alarm sound. A Xbee RF module board (5) is wired directly into an alarm signal device (4). Therefore the same signal that the electronic chip (3) sends to the alarm signal device (4) is also sent to the Xbee RF module board (5). The Xbee RF module board (5) transmits a signal to the Electric Shut Off System (FIG. 3) at the same time that the smoke alarm is sounding.

### DETAILED DESCRIPTION AND OPERATION OF THE ELECTRIC ALARM SHUT OFF SYSTEM (FIG. 3)

The Electric Shut Off System is powered from a 110 V AC (6), using a 5V AC DC converter (7). The Electric Shut Off System receives the transmitted signal from a smoke detector (FIG. 1) via another Xbee module board (8) configured as a receiver. A PIC microcontroller (9) controls the functionality of the Electric Shut Off System. When the Electric Shut Off System is armed (turned on) the PIC microcontroller (9) causes a green LED (10) to light. Upon receiving a signal from a Xbee module board receiver (8) a PIC microcontroller (9) will cause a yellow LED (11) to light. PIC lights are set by a user controller potentiometer (13). If at the end of the delay time the user has not turned off the Electric Alarm Shut Off System with an off button (15), or pressed a reset button (14), the PIC microcontroller (9) will send a signal through an electrical Cord (16) to an electric 4 pole contactor (17). The electric 4 pole contractor (17) will disconnect the incoming flow of electric from the electric appliance. This will prevent the smoke from growing into a fire. Thus, lives and property have been saved.

RESET: The user may restore the supply of electric to an appliance by pressing a reset button (14). A green LED will come on. The green LED means that the Electric Shut System is reset and armed again.

### DETAILED DESCRIPTION AND OPERATION OF THE ELECTRIC TELEPHONE INTERFACE SYSTEM (FIG. 4)

The system plugs into a standard phone jack (26) and is connected to the Shut Off Unit using a standard phone cord (18). When the Shut Off Unit has disconnected the supply of electricity from the appliance and the user is away from the house a Telephone Interface System will notify the user of the action of the Shut Off System by dialing a preprogrammed telephone number and playing a prerecorded message.

Operation of the Telephone Interface System (FIG. 4), following the numbering system of the Electric Shut Off System (FIG. 3): When the Shut Off Units (FIG. 3) disconnects the supply of electricity a Telephone Interface System (FIG. 4) will dial a phone number using a tone generator IC (19) and play a short message using a voice synthesis IC (20). A liquid crystal display (LCD) (21) is used to provide the user with feedback and instructions. A keypad (22) allows the user to enter a telephone number and respond to prompts. Pressing a specific key on the keypad (such as the # key) will initiate a process whereby the user is directed to enter a number to be dialed when the unit has disconnected and also to record a short message using the microphone (23). This message will be played to the user upon pick-up of a remote phone (the number that the Telephone Interface System will dial).

The Telephone Interface System also allows the user to disconnect the supply of gas or electricity from the appliance remotely (if the user forgets to turn the appliance off before leaving home). Using a remote phone (or a telephone at another location) the user will dial the phone to which the Shut Off System is connected and enter a code using a touch-tone phone key. A tone detector IC (24) will decode the code and a PIC microcontroller (25) will compare it to a code previously programmed into the Shut Off System, via a keypad and LCD. If the code matches then the gas or electricity will be disconnected. The system will provide the user with confirmation of the disconnection by means of a short beep.

1. A Gas Alarm Shut Off System with a Telephone Interface System comprising:
A smoke detector having a battery, a smoke sensor, an electronic chip, an alarm signal device, a Xbee RF module board.
A gas shut off system having an electric wall plug in card, an AC DC converter, a Xbee receiver, a PIC microcontroller, a green led, a yellow led, a red led, a potentiometer, a reset button, an on an off switch, and electric gas solenoid cord, a gas solenoid valve.
A telephone interface system having a tone generator, a voice synthesis, a LCD, a keypad, a microphone, a tone decoder, a PIC microcontroller, two phone cords.

2. An Electric Alarm Shut Off System with a Telephone Interface System comprising:
A smoke detector having a battery, a smoke sensor, an electronic chip, an alarm signal device, a Xbee RF module.
An electric shut off system having an electric wall plug in cord, an AC DC converter, a Xbee receiver, a PIC microcontroller, a green led, a yellow led, a red led, a potentiometer, a reset button, an on and off switch, an electric 4 pole contactor cord, an electric 4 pole contactor.
A telephone interface system having a tone generator, a voice synthesis, a LCD, a keypad, a microphone, a tone decoder, a PIC microcontroller, two phone cords.
